(19) United States
(12) Patent Application Publication
(10) Pub. No.: US 2010/0211291 A1
(43) Pub. Date: Aug. 19, 2010

(54) ABNORMALITY DETECTION DEVICE

(75) Inventors: Shinya Sumitani, Nagoya-city (JP); Kazuhiko Ooshima, Anjo-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/510,365

(22) Filed: Jul. 28, 2009

(30) Foreign Application Priority Data
Jul. 28, 2008 (JP) 2008-193758

(51) Int. Cl. F02D 45/00

(52) U.S. Cl. 701/104

(57) ABSTRACT

An abnormality detection device determines whether an injection correction amount of each cylinder at the time when maximum rotation numbers are equalized is outside a normal range if the equalization of the maximum rotation numbers among cylinders is completed in an idle stable state. The abnormality detection device determines that an abnormality exists on an injector side if the injection correction amount of a specific cylinder is outside the normal range and a rotation number fluctuation difference of the specific cylinder is in a normal range. The abnormality detection device determines that the abnormality exists on an engine side if the injection correction amount of a specific cylinder is outside the normal range and the rotation number fluctuation difference of the specific cylinder is outside the normal range.

### CROSS REFERENCE TO RELATED APPLICATION

This application is based on and incorporates herein by reference Japanese Patent Application No. 2008-193758 filed on Jul. 28, 2008.

### BACKGROUND OF THE INVENTION

1. Field of the Invention:

The present invention relates to an abnormality detection device of a fuel injection system that injects fuel from injectors mounted to respective cylinders of an internal combustion engine to the cylinders.

2. Description of Related Art:

Conventionally, an internal combustion engine having multiple cylinders has been required to realize a stable operation state by reducing fluctuation of rotation characteristics among the cylinders (for example, fluctuation of rotation number, i.e., rotation speed) or variation in maximum rotation number among the cylinders, irrespective of whether the internal combustion engine is a gasoline engine or a diesel engine. For example, if uniform injection characteristics among the cylinders can be obtained by improving manufacturing accuracy of injectors, the variation in the rotation characteristics among the cylinders can be reduced.

However, there is a limit in the improvement of the manufacturing accuracy, and a manufacturing cost will rise. Even if the manufacturing accuracy of the injector is heightened, there is still a problem that the injection characteristics of the injector change for each cylinder due to an aging change.

Therefore, as described in Patent document 1 (JP-A-H6-50077) or Patent document 2 (JP-A-H7-59911), a scheme of reducing the variation in the rotation speed among the cylinders or equalizing the maximum rotation numbers among the cylinders by correcting injection quantities of the injectors mounted to the respective cylinders may be employed.

When the injection quantity of the injector is corrected to reduce the variation in the rotation characteristics such as the rotation speed or the maximum rotation number among the cylinders, the injection quantity of the injector cannot be corrected limitlessly. Rather, there is set a guaranteed range where the correction is possible. Determination of whether an injection correction amount is outside the guaranteed range enables detection of occurrence of an abnormality in a specific cylinder, whose injection correction amount has deviated from the guaranteed range.

However, the abnormality in the injection characteristics of the injector is not the sole cause of the deviation of the injection correction amount of the specific cylinder from the guaranteed range. It is thought that the causes of the deviation include increase in a sliding resistance between a piston and the cylinder of the internal combustion engine and an abnormality in an internal combustion engine main body such as defective compression of the cylinder.

The technology of Patent document 1 or 2 can detect the occurrence of the abnormality in the specific cylinder when the injection correction amount deviates from the guaranteed range. However, the technology has a shortcoming that the technology cannot distinguish whether the cause of the abnormality exists on the injector side or on the internal combustion engine side (engine side). The injector side means an injection system that includes the injector and that supplies fuel to the injector and injects the fuel to the cylinder. The internal combustion engine side means a torque generation system that includes the internal combustion engine main body and that generates torque by combusting the fuel injected by the injector.

### SUMMARY OF THE INVENTION

It is an object of the present invention to provide an abnormality detection device that distinguishes whether a cause of an abnormality exists on an injector side or on an internal combustion engine side when an injection correction amount of the injector at the time when maximum rotation numbers are equalized among cylinders deviates from a normal range.

If an injection correction amount of an injector of a specific cylinder deviates from a normal range when injection quantities of injectors are corrected and maximum rotation numbers are equalized among the cylinders, it can be determined that an abnormality is caused on either of the injector side or the internal combustion engine side of the corresponding specific cylinder. If the internal combustion engine side is normal in the specific cylinder causing the abnormality, a rotation characteristic different from the maximum rotation number falls within a normal range.

If the internal combustion engine side is abnormal in the specific cylinder causing the abnormality, the rotation characteristic different from the maximum rotation number does not fall within the normal range but deviates from the normal range.

Therefore, according to an aspect of the present invention, an abnormality detection device has an equalizing section, a correction amount determining section, a rotation characteristic determining section and an abnormality determining section. The equalizing section equalizes maximum rotation numbers out of rotation characteristics of cylinders among the cylinders by correcting injection quantities of injectors. The correction amount determining section determines whether a correction amount of the injection quantity of each cylinder at the time when the equalizing section equalizes the maximum rotation numbers is in a normal range. The rotation characteristic determining section determines whether a rotation characteristic of each cylinder different from the maximum rotation number at the time when the equalizing section equalizes the maximum rotation numbers is in a normal range. The abnormality determining section determines that an abnormality exists on an injector side if the correction amount determining section determines that the correction amount of a specific cylinder is outside the normal range and the rotation characteristic determining section determines that the rotation characteristic of the specific cylinder different from the maximum rotation number is in the normal range. The abnormality determining section determines that an abnormality exists on an internal combustion engine side if the correction amount determining section determines that the correction amount of a specific cylinder is outside the normal range and the rotation characteristic determining section determines that the rotation characteristic of the specific cylinder different from the maximum rotation number is outside the normal range.

The rotation number and rotation speed of the cylinder indicate substantially the same rotation characteristic. Therefore, the rotation number may be replaced with the rotation speed.

In this way, when the injection correction amount of a specific cylinder at the time when the maximum rotation numbers are equalized among the cylinders deviates from the normal range and the abnormality occurs, it can be determined whether the cause of the abnormality in the specific cylinder is on the injector side or on the internal combustion engine side by determining whether the rotation characteristic different from the maximum rotation number is in the normal range in the specific cylinder.

According to anther aspect of the present invention, the rotation characteristic different from the maximum rotation number is a rotation number difference between the maximum rotation number and the minimum rotation number of each cylinder.

Thus, the rotation characteristic different from the maximum rotation number can be easily detected from the two values of the maximum rotation number and the minimum rotation number.

According to another aspect of the present invention, the rotation characteristic different from the maximum rotation number is an integration value of the rotation number of each cylinder.

The integration value of the rotation number (i.e., a work amount of each cylinder) can be calculated with high accuracy by increasing the number of sampling points of the rotation number of each cylinder as much as possible. Thus, when the injection correction amount of a specific cylinder at the time when the maximum rotation numbers are equalized deviates from the normal range and the abnormality is caused in the specific cylinder, it can be accurately distinguished whether the cause of the abnormality is on the injector side or on the internal combustion engine side based on the integration value of the rotation number of each cylinder.

According to another aspect of the present invention, an execution condition determining section determines that an execution condition for the equalizing section to equalize the maximum rotation numbers is satisfied when an operation of the internal combustion engine is an idle operation and also a no-load operation.

Thus, when the operation is the idle operation and also the no-load operation in which disturbance is small, the injection correction amount at the time when the maximum rotation numbers are equalized can be detected with high accuracy.

The injection quantity of the injector increases when the operation is not the no-load operation and a load is applied to the internal combustion engine. If the injection quantity increases, reference injection quantity of the normal range for determining whether the injection quantity of each cylinder at the time when the maximum rotation numbers are equalized among the cylinders is in the normal range also increases with the increase in the injection quantity.

Therefore, according to yet another aspect of the present invention, when a load is applied to the internal combustion engine, the execution condition determining section determines that the execution condition for the equalizing section to equalize the maximum rotation numbers is satisfied if an operation state of the internal combustion engine is a certain operation state, in which reference injection quantity of the injector can be set in accordance with the load.

Thus, in the operation state where the load is applied to the internal combustion engine, it can be determined whether the cause of the abnormality of the specific cylinder causing the abnormality is on the injector side or on the internal combustion engine side.

The functions of the multiple sections according to the present invention may be realized by hardware resources having functions specified by constructions thereof, hardware resources having functions specified by programs, or a combination of both types of the hardware resources. The functions of the sections are not limited to the functions realized by the hardware resources, which are physically separated from each other.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1A is a block diagram showing a fuel injection system according to an embodiment of the present invention;

FIG. 1B is a schematic diagram showing a diesel engine according to the embodiment;

FIG. 2 is a time chart showing rotation characteristics and injection correction amounts of cylinders according to the embodiment;

FIG. 3 is a characteristic diagram showing injection quantities and rotation number fluctuation differences of the cylinders in a normal state according to the embodiment;

FIGS. 4A and 4B are characteristic diagrams each showing the injection quantities and the rotation number fluctuation differences in the case of an injector-side abnormality of a specific cylinder according to the embodiment;

FIGS. 5A and 58 are characteristic diagrams each showing the injection quantities and the rotation number fluctuation differences in the case of an engine-side abnormality of a specific cylinder according to the embodiment;

FIG. 6 is a characteristic diagram explaining abnormality detection according to the embodiment;

FIG. 7 is a flowchart showing an abnormality detection routine 1 according to the embodiment; and

FIG. 8 is a flowchart showing an abnormality detection routine 2 according to the embodiment.

### DETAILED DESCRIPTION OF EXAMPLE EMBODIMENT

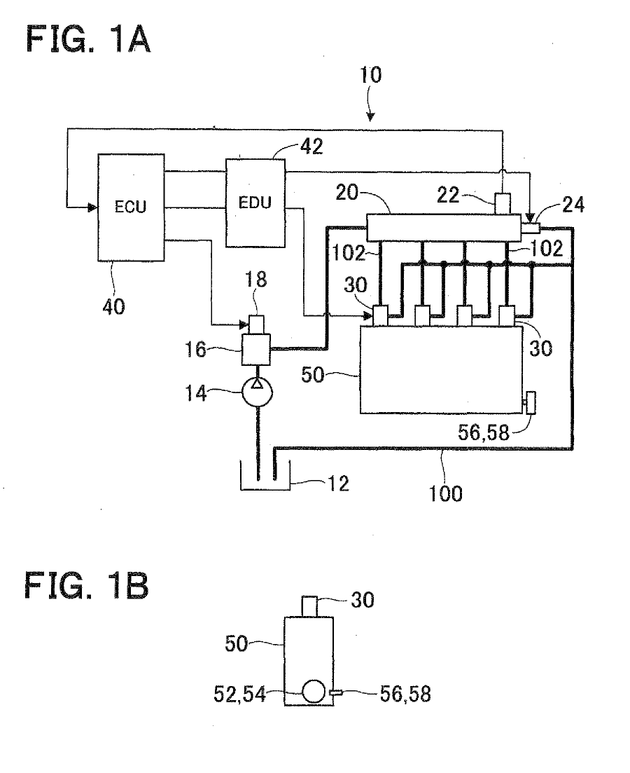

Hereinafter, an embodiment of the present invention will be described with reference to the drawings. FIG. 1A shows a fuel injection system 10 according to the present embodiment.

(Fuel Injection System 10)

A pressure accumulation fuel injection system 10 according to the present embodiment is constituted by a feed pump 14, a high-pressure pump 16, a common rail 20, a pressure sensor 22, a pressure reducing valve 24, injectors 30, an electronic control unit 40 (ECU), an electronic driving unit 42 (EDU) and the like. The fuel injection system 10 injects fuel into cylinders of a four-cylinder diesel engine 50 (shown in FIG. 1B and will be also referred to simply as an engine hereafter). In order to avoid complication of the diagram, only a single control signal line from the EDU 42 to one injector 30 is shown in FIG. 1A.

The feed pump 14 suctions the fuel from a fuel tank 12 and supplies the fuel to the high-pressure pump 16, which is a fuel supply pump. The high-pressure pump 16 is a well-known pump, in which a plunger reciprocates with rotation of a cam of a camshaft, thereby suctioning the fuel into a pressurization chamber and pressurizing the suctioned fuel. The ECU 40 controls a value of current supplied to a metering valve 18 of the high-pressure pump 16 to meter quantity of the fuel suctioned by the high-pressure pump 16 during a suction stroke. Fuel discharge quantity of the high-pressure pump 16 is metered by metering the fuel suction quantity.

The common rail 20 accumulates the fuel pumped by the high-pressure pump 16 and holds fuel pressure to predetermined high pressure corresponding to an engine operation state. The pressure sensor 22 as a pressure sensing device senses the fuel pressure inside the common rail 20 and outputs the sensed fuel pressure to the ECU 40.

The pressure reducing valve 24 opens to discharge the fuel in the common rail 20 to a return pipe 100 on a low-pressure side. For example, the pressure reducing valve 24 is a well-known electromagnetic valve that applies a load of a spring to a valve member in a valve-closing direction and that opens when an electromagnetic drive section such as a coil is energized and the valve member lifts against the load of the spring. A valve opening time of the pressure reducing valve 24 lengthens in accordance with pulse width (an energization time) of an energization pulse applied to the pressure reducing valve 24. A pressure limiter may be provided in place of the pressure reducing valve 24.

The injector 30 is mounted to each cylinder of the four-cylinder diesel engine 50 and injects the fuel, which is accumulated in the common rail 20 under pressure, into the cylinder. The injector 30 performs multiple injection (multi-stage injection) including pilot injection and post-injection before and after main injection in a single combustion cycle based on an operation state of the engine 50. The injector 30 and the common rail 20 are connected with each other via an injection pipe 102. The injector 30 is a well-known electromagnetic drive injector that controls fuel injection quantity by controlling pressure of a control chamber applying fuel pressure to a nozzle needle in a valve closing direction.

The ECU 40 as an abnormality detection device is constituted by a microcomputer consisting mainly of CPU, ROM, RAM, a rewritable flash memory, an input-output interface and the like.

The ECU 40 obtains the operation state of the engine 50 from output signals of various sensors such as an accelerator sensor that senses a position (ACC) of an accelerator, a coolant temperature sensor, the pressure sensor 22, an NE sensor 56 that senses engine rotation number (NE) and a cylinder determination sensor 58 that distinguishes the cylinder. The ECU 40 takes in the output signals from the various sensors and controls the engine operation state. For example, the ECU 40 controls the discharge quantity of the high-pressure pump 16, opening and closing of the pressure reducing valve 24, the injection quantity and injection timing of the injector 30 and a pattern of the multiple injection in the case where the pilot injection, the post-injection and the like are performed before and after the main injection. The ECU 40 outputs a pulse signal to the EDU 42 as an injection control signal for controlling the injection timing and the injection quantity of the injector 30.

The EDU 42 is a drive device for supplying drive currents or drive voltages to the pressure reducing valve 24 and the injector 30 based on the control signals outputted by the ECU 40.

An NE pulse device 52 for sensing the engine rotation number NE and a cylinder determination pulse device 54 for determining a cylinder position of the engine 50 are provided to a crankshaft of the engine 50. Multiple projections are provided to the NE pulse device 52 at predetermined angular intervals along a circumferential direction. The NE sensor 56 outputs the pulse signal every time the NE sensor 56 detects the projection of the NE pulse device 52 rotating with the crankshaft. The ECU 40 senses the engine rotation number NE from the number of the pulse signals outputted by the NE sensor 56 per unit time.

A projection for determining the cylinder positions of the four cylinders of the diesel engine 50 is provided to the cylinder determination pulse device 54 at a specified angular position. The cylinder determination sensor 58 outputs the pulse signal if the cylinder determination sensor 58 detects the projection of the cylinder determination pulse device 54 for determining the cylinder position. The ECU 40 senses the crank angle of the engine 50 based on the pulse signals outputted by the NE sensor 56 and the cylinder determination sensor 58.

Functional sections of the ECU 40, which functions as the abnormality detection device for detecting an abnormality of each cylinder based on control programs stored in the ROM or the flash memory of the ECU 40, will be explained below.

(Execution Condition Determining Section)

The ECU 40 determines whether an execution condition for equalizing the maximum rotation numbers among the cylinders is satisfied. The ECU 40 determines that the execution condition for equalizing the maximum rotation numbers is satisfied when an operation of the internal combustion engine 50 is idle operation and also no-load operation. The maximum rotation number is one of rotation characteristics of each cylinder. Rotation characteristics different from the maximum rotation number of each cylinder include a rotation number fluctuation difference, which is a difference between the maximum rotation number and the minimum rotation number, an integration value of the rotation number and the like.

The ECU 40 determines that the operation is the idle operation and also the no-load operation when all of following conditions (A) to (F) are satisfied.

(A) A vehicle is stopped (i.e., vehicle speed is 0).

(B) The engine rotation number NE is equal to or lower than a predetermined rotation number.

(C) The accelerator is released.

(D) A clutch is not connected.

(E) The coolant temperature is equal to or higher than predetermined temperature and warm-up of the engine 50 has been completed.

(F) Accessories are switched off.

(Equalizing Section)

If the execution condition determining section determines that the execution condition for equalizing the maximum rotation numbers is satisfied, the ECU 40 equalizes the maximum rotation numbers by correcting the injection quantities of the respective cylinders such that the maximum rotation numbers of the respective cylinders reside within a predetermined rotation number range.

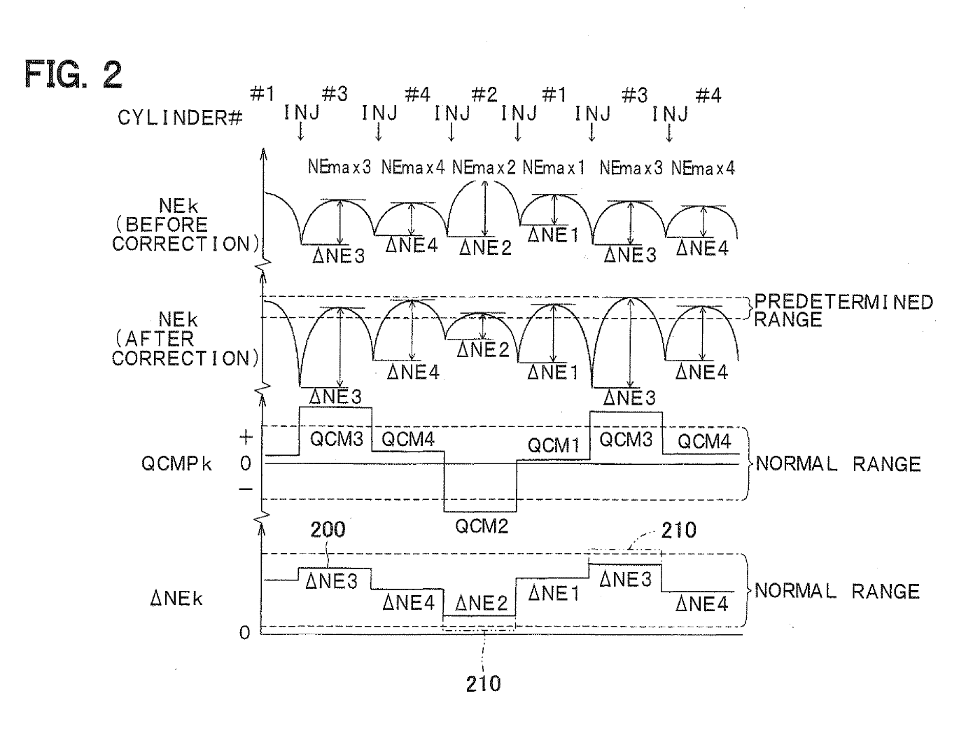

More specifically, as shown in FIG. 2, the ECU 40 senses the maximum rotation numbers of the four cylinders respectively based on the output signal of the NE sensor 56 (refer to rotation fluctuations NEk of the respective cylinders #1 to #4 before the correction shown in FIG. 2). INJ in FIG. 2 indicates the injection timing in each cylinder. If the operation is the idle operation and also the no-load operation, the ECU 40 controls the injection quantities of the respective cylinders to achieve a target rotation number set in accordance with the operation state and corrects the injection quantities of the respective cylinders to conform the maximum rotation number of a certain cylinder to the maximum rotation number of an immediately preceding cylinder in the injection order. Thus, the ECU 40 limits the maximum rotation numbers of the respective cylinders within a predetermined range (refer to the rotation fluctuations NEk of the respective cylinders #1 to #4 after the correction shown in FIG. 2).

In FIG. 2, NEmaxk (k=1, 2, 3, 4) represent the maximum rotation numbers of the respective cylinders. ΔNEk (k=1, 2, 3, 4) are rotation number fluctuation differences, each of which is a difference between the maximum rotation number (NEmaxk) and the minimum rotation number of each cylinder. QCMPk (k=1, 2, 3, 4) are injection correction amounts of the respective cylinders with respect to the reference injection quantity at the time when the maximum rotation numbers NEmaxk are equalized. The reference injection quantity represents the injection quantity that is commanded to the normal injector 30 based on a predetermined operation state when both of the injector 30 side and the engine 50 side are normal. The reference injection quantity changes with the operation state.

(Correction Amount Determining Section)

The ECU 40 determines whether the injection correction amount of each cylinder (QCMPk in FIG. 2) with respect to the reference injection quantity at the time when the maximum rotation numbers are equalized among the cylinders resides within a normal range. The reference injection quantity corresponds to the zero position of the injection correction amounts QCMPk of the cylinders shown in FIG. 2.

In the example of FIG. 2, the injection correction amounts QCMP2, QCMP3 of the second and third cylinders #2, #3 are outside the normal range. The injection correction amount QCMP2 of the second cylinder #2 deviates from the normal range on a decrease (−) side. The injection correction amount QCMP3 of the third cylinder #3 deviates from the normal range on an increase (+) side. If the injection correction amount QCMPk at the time when the maximum rotation numbers NEmaxk are equalized among the cylinders is outside the normal range, it is thought that there occurs an abnormality on the injector 30 side or on the engine 50 side in a corresponding specific cylinder.

(Rotation Characteristic Determining Section)

The ECU 40 determines whether a rotation characteristic different from the maximum rotation number NEmaxk is in a normal range in each cylinder when the maximum rotation numbers NEmaxk are equalized among the cylinders. In the example of FIG. 2, the ECU 40 determines whether the rotation number fluctuation difference ΔNEk is in a normal range in each cylinder when the maximum rotation numbers NEmaxk are equalized among the cylinders. In an example shown by a solid line 200 in the lowest part of FIG. 2, the rotation number fluctuation differences ΔNEk (ΔNE1 to ΔNE4) of all the cylinders #1 to #4 including the second and third cylinders #2, #3 reside within the normal range though the injection correction amounts QCMP2, QCMP3 of the second and third cylinders #2, #3 are outside the normal range. In another example shown by a chain double-dashed line 210, the rotation number fluctuation differences ΔNEk (ΔNE2 and ΔNE3) of the second and third cylinders #2, #3, whose injection correction amounts QCMP2, QCMP3 are outside the normal range, are outside the normal range.

(Abnormality Determining Section)

(1) Normal state

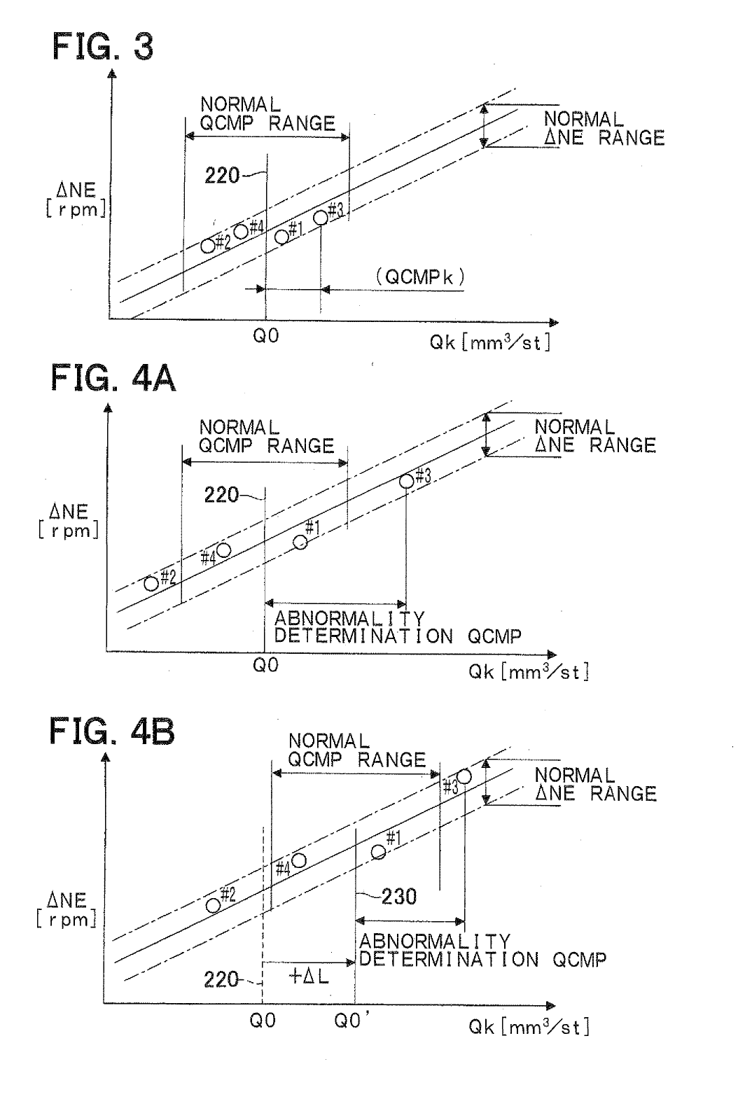

The ECU 40 determines that both of the injector 30 side and the engine 50 side are normal if the injection correction amounts QCMPk of all the four cylinders #1 to #4 at the time when the maximum rotation numbers NEmaxk are equalized among the cylinders reside within the normal range with respect to reference injection quantity Q0 (shown by a solid line 220 in FIG. 3) at the time when the operation is the idle operation and also the no-load operation.

(2) Abnormality on injector 30 side

The ECU 40 determines that the engine 50 side is normal and the abnormality is caused on the injector 30 side if the injection correction amount QCMPk of a specific cylinder (the second and third cylinders #2, #3 in FIG. 2, 4A, 4B, 5A or 5B) at the time when the maximum rotation numbers NEmaxk are equalized among the cylinders is outside the normal range and the rotation number fluctuation difference ΔNEk of the specific cylinder resides within the normal range as shown by the solid line 200 in FIG. 2 or as shown in FIG. 4A.

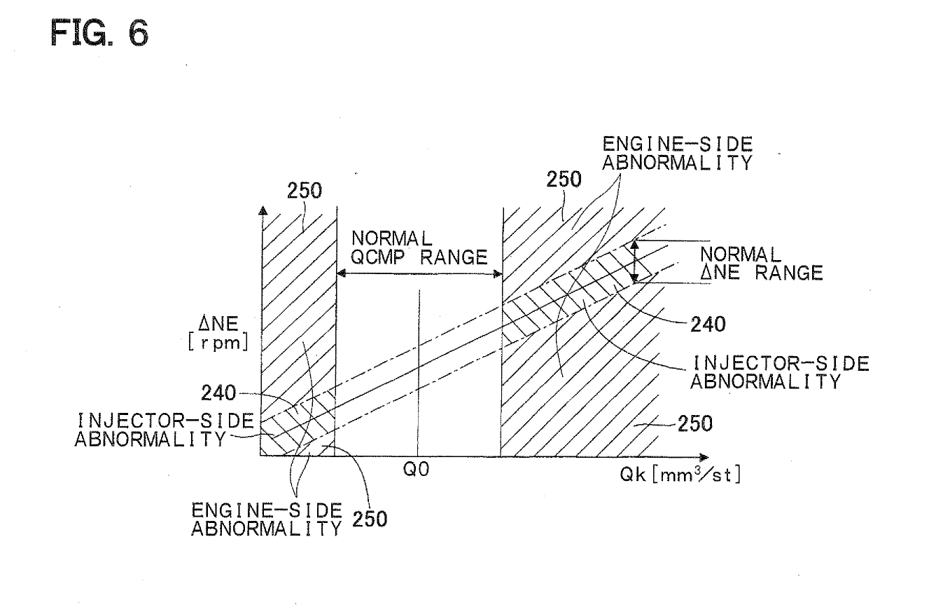

That is, the ECU 40 determines that the engine 50 side is normal and the abnormality is caused on the injector 30 side if the injection correction amount of a specific cylinder at the time when the maximum rotation numbers are equalized among the cylinders is outside the normal range and the rotation number fluctuation difference ΔNE of the specific cylinder resides in an area 240 (shown in FIG. 6) within the normal range.

In FIG. 2, the normal range of the rotation number fluctuation difference ΔNE is fixed. However, practically, upper and lower threshold values of the normal range of the rotation number fluctuation difference ΔNE increase as the injection quantity Qk increases, and the normal range makes parallel transition as shown in FIGS. 3 to 5B. Qk in FIGS. 3 to 6 represents the injection quantity of each cylinder.

(3) Abnormality on engine 50 side

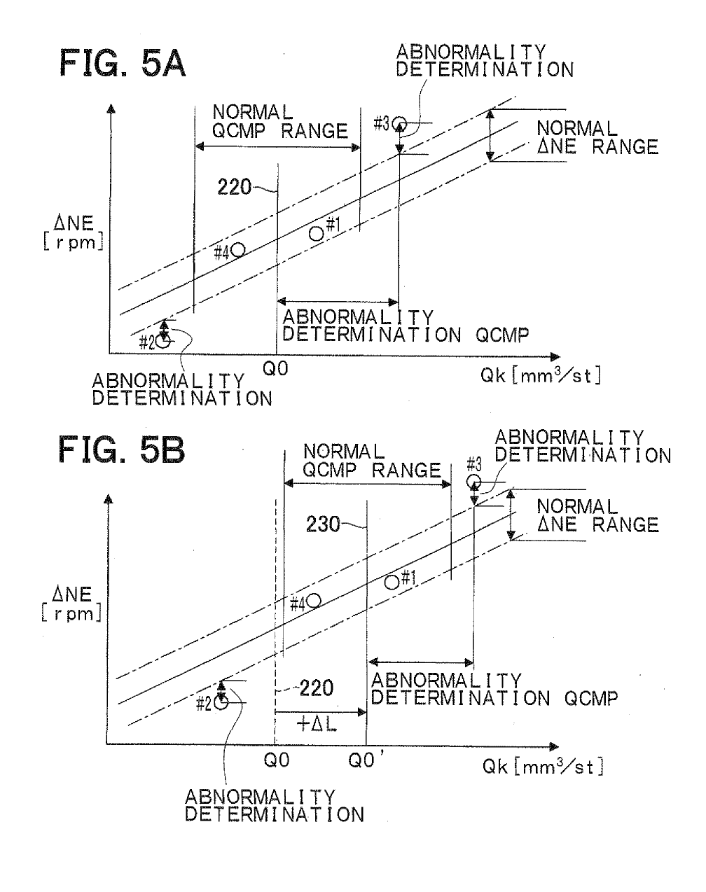

The ECU 40 determines that the injector 30 side is normal and the abnormality is caused on the engine 50 side if the injection correction amount QCMPk of a specific cylinder (the second and third cylinders #2, #3 in FIG. 2, 4A, 4B, 5A or 5B) at the time when the maximum rotation numbers NEmaxk are equalized among the cylinders is outside the normal range and the rotation number fluctuation difference ΔNEk of the specific cylinder is outside the normal range as shown by the chain double-dashed line 210 in FIG. 2 or as shown in FIG. 5A.

That is, the ECU 40 determines that the injector 30 side is normal and the abnormality is caused on the engine 50 side if the injection correction amount QCMPk of a specific cylinder at the time when the maximum rotation numbers NEmaxk are equalized among the cylinders is outside the normal range and the rotation number fluctuation difference ΔNE of the specific cylinder resides in an area 250 (shown in FIG. 6) outside the normal range.

The execution condition for equalizing the maximum rotation numbers NEmaxk among the cylinders is satisfied in the case where the operation is the idle operation and also the no-load operation in the examples of FIGS. 3, 4A and 5A. Alternatively, in addition to the no-load operation, the execution condition for equalizing the maximum rotation numbers NEmaxk may be determined to be satisfied also when a load is applied to the engine 50 as long as the operation state is a certain operation state, in which the reference injection quantity for determining whether the injection correction amount of the injector 30 is in the normal range can be set based on the load.

Each of FIGS. 4B and 5B shows the injection quantities Qk and the rotation number fluctuation differences ΔNE of the cylinders in the case of the engine operation state, in which the load (ΔL) is applied to the engine 50 and the injection quantity Qk increases. The injection quantities Qk and the rotation number fluctuation differences ΔNE of the cylinders increase to make a transition parallel to those in the case of the no load. In this case, there can be a case where the reference injection quantity Q0′ (shown by a solid line 230) can be set based on the operation state in which the load ΔL is applied to the engine 50 as shown in FIG. 4B or FIG. 5B. In such the case, when the injection correction amount QCMPk of a specific cylinder (the second and third cylinders #2, #3 in FIG. 2, 4A, 4B, 5A or 5B) at the time when the maximum rotation numbers NEmaxk are equalized among the cylinders is outside the normal range, it can be determined whether the cause of the abnormality of the specific cylinder exists on the injector 30 side or on the engine 50 side by determining whether the rotation number fluctuation difference ΔNEk of the specific cylinder is within the normal range as shown in FIG. 4B or FIG. 5B as in the case of the no load. The normal range of the injection correction amount QCMP may be widened in accordance with the increase of the injection quantity Qk when the engine 50 is in a certain operation state, in which the reference injection quantity (shown by the solid line 230) increases compared with the case of the operation that is the idle operation and also the no-load operation as shown in FIG. 4B or 5B.

(Abnormality detection)

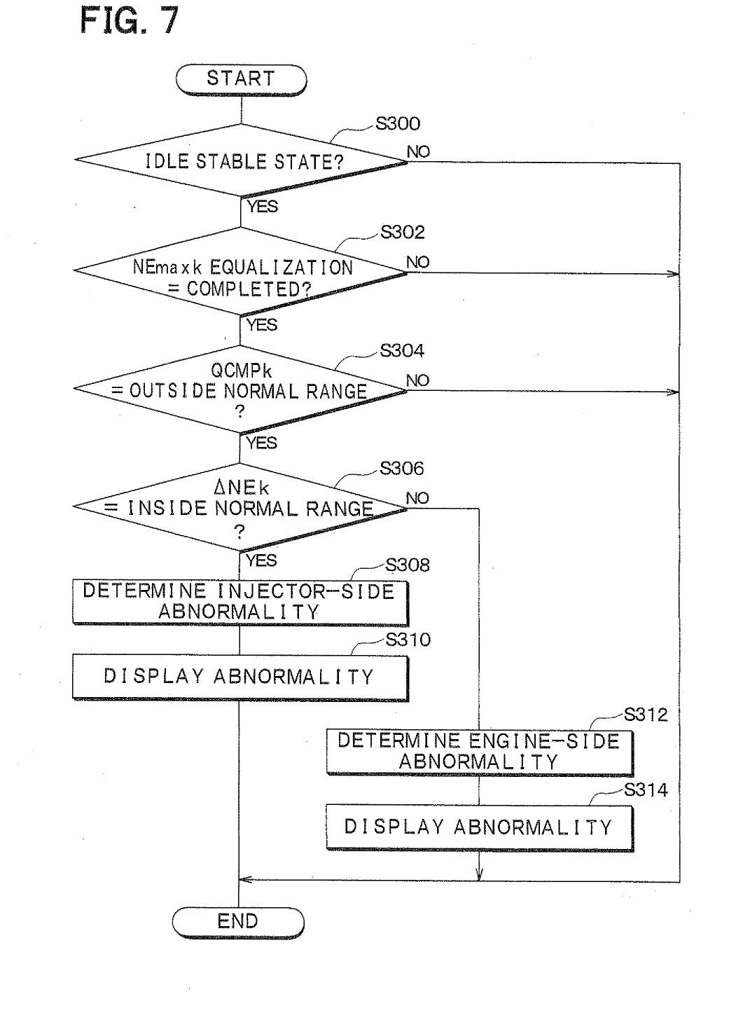

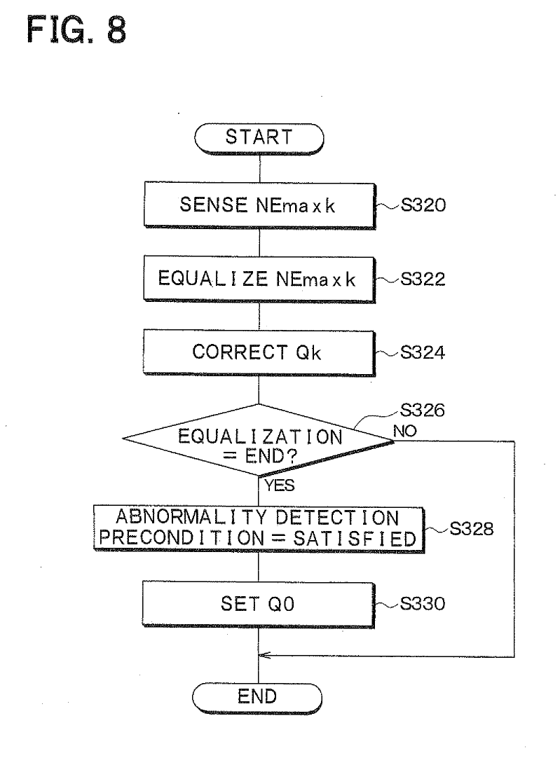

Next, abnormality detection routines 1 and 2 respectively shown in FIGS. 7 and 8 will be explained. In FIGS. 7 and 8, “S” means “Step.” The abnormality detection routines 1 and 2 shown in FIGS. 7 and 8 are executed constantly. The abnormality detection routine 2 of FIG. 8 explains details of S302 of the abnormality detection routine 1 of FIG. 7,

(Abnormality detection routine 1)

In S300 of FIG. 7, the ECU 40 determines whether the engine 50 is in an idle stable state, in which the idle operation and the no-load operation are established. The idle operation and the no-load operation are established when all the conditions (A) to (F) explained in the above description of the “execution condition determining section” are satisfied. When the engine 50 is not in the idle stable state and the execution condition of the abnormality detection is not satisfied (S300: No), the ECU 40 ends the routine.

When the engine 50 is in the idle stable state and the execution condition of the abnormality detection is satisfied (S300: Yes), the ECU 40 determines in S302 whether the equalization of the maximum rotation numbers NEmaxk among the cylinders has been completed. If the equalization has not been completed (S302: No), the ECU 40 ends the routine.

If the equalization has been completed (S302: Yes), the ECU 40 determines in S304 whether the injection correction amount QCMPk of each cylinder at the time when the maximum rotation numbers NEmaxk are equalized among the cylinders is outside the normal range. If the injection correction amounts QCMPk of all the cylinders are inside the normal range (S304: No), the ECU 40 ends the routine.

If the injection correction amount QCMPk of a specific cylinder at the time when the maximum rotation numbers NEmaxk are equalized among the cylinders is outside the normal range (S304: Yes), the ECU 40 determines that the abnormality is caused on the injector 30 side or on the engine 50 side in the specific cylinder. Therefore, in S306, the ECU 40 determines whether the rotation number fluctuation difference ΔNEk is in the normal range in the specific cylinder, whose injection correction amount QCMPk is outside the normal range.

If the rotation number fluctuation difference ΔNE is in the normal range in the specific cylinder (S306: Yes), whose injection correction amount QCMPk is outside the normal range, the ECU 40 determines in S308 that the engine 50 side is normal and the abnormality is caused on the injector 30 side. Then, in S310, the ECU 40 reports the occurrence of the abnormality on the injector 30 side with the use of a warning light, a warning sound or the like.

If the rotation number fluctuation difference ΔNE is outside the normal range in the specific cylinder (S306: No), whose injection correction amount QCMPk is outside the normal range, the ECU 40 determines in S312 that the injector 30 side is normal and the abnormality is caused on the engine 50 side. Then in S314, the ECU 40 reports the occurrence of the abnormality on the engine 50 side with the use of a warning light, a warning sound or the like.

(Abnormality detection routine 2)

As described above, the abnormality detection routine 2 of FIG. 8 expresses the details of the processing of S302 of the abnormality detection routine 1 of FIG. 7. In S320 of FIG. 8, the ECU 40 senses the maximum rotation numbers NEmaxk of the respective cylinders based on the output signal of the NE sensor 56. The ECU 40 calculates an average value of the maximum rotation numbers NEmaxk of all the cylinders (in S322) and corrects the injection quantities Qk of the cylinders to substantially equalize the maximum rotation numbers NEmaxk of all the cylinders with respect to the average value (in S324). The ECU 40 ends the routine when the maximum rotation numbers NEmaxk of the cylinders are not substantially equalized to each other (S326: No).

If the maximum rotation numbers NEmaxk of the respective cylinders are substantially equalized to each other (S326: Yes), the ECU 40 determines that a precondition for performing the abnormality detection before the determination of the rotation number fluctuation difference ΔNE is satisfied (in S328) and calculates the reference injection quantity Q0 of the injector 30 at the time when the operation is the idle operation and also the no-load operation.

According to the above-described embodiment, it is determined that the abnormality is caused in a specific cylinder if the injection correction amount at the time when the maximum rotation numbers are equalized among the cylinders is outside the normal range. Moreover, it is determined whether the rotation number fluctuation difference as the difference between the maximum rotation number and the minimum rotation number is in the normal range in the specific cylinder. Thus, it can be determined whether the cause of the abnormality in the specific cylinder is on the injector 30 side or on the engine 50 side.

(Other embodiment)

In the above-described embodiment, the present invention is applied to the fuel injection system 10 using the common rail diesel engine 50. In addition to the construction, the present invention may be applied to any kind of internal combustion engine if injection quantities of injectors mounted to multiple cylinders respectively can be corrected.

In the above-described embodiment, the injection quantity that can be set based on the predetermined load including the no load is used as the reference injection quantity. Further, it is determined whether the abnormality exists in the cylinder based on whether the injection correction amount of each cylinder at the time when the maximum rotation numbers are equalized among the cylinders is within the normal range with respect to the reference injection quantity. Alternatively, an average value of the command injection quantities of the respective cylinders at the time when the maximum rotation numbers are equalized among the cylinders may be used as the reference injection quantity.

In the above-described embodiment, the functions of the equalizing section, the correction amount determining section, the rotation characteristic determining section, the abnormality determining section and the execution condition determining section are realized by the ECU 40, whose functions are specified by the control programs. Alternatively, at least a part of the functions of the above-described multiple sections may be realized with hardware, whose functions are specified by its circuit configuration.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. An abnormality detection device of a fuel injection system that injects fuel from injectors mounted in respective cylinders of an internal combustion engine to the cylinders, the abnormality detection device comprising:
an equalizing means for equalizing maximum rotation numbers out of rotation characteristics of the cylinders among the cylinders by correcting injection quantities of the injectors;
a correction amount determining means for determining whether a correction amount of the injection quantity of each cylinder at the time when the equalizing means equalizes the maximum rotation numbers is in a normal range;
a rotation characteristic determining means for determining whether a rotation characteristic of each cylinder different from the maximum rotation number at the time when the equalizing means equalizes the maximum rotation numbers is in a normal range; and
an abnormality determining means for determining that an abnormality exists on an injector side if the correction amount determining means determines that the correction amount of a specific cylinder is outside the normal range and the rotation characteristic determining means determines that the rotation characteristic of the specific cylinder different from the maximum rotation number is in the normal range and for determining that an abnormality exists on an internal combustion engine side if the correction amount determining means determines that the correction amount of a specific cylinder is outside the normal range and the rotation characteristic determining means determines that the rotation characteristic of the specific cylinder different from the maximum rotation number is outside the normal range.

2. The abnormality detection device as in claim 1, wherein
the rotation characteristic different from the maximum rotation number is a rotation number difference between the maximum rotation number and the minimum rotation number of each cylinder.

3. The abnormality detection device as in claim 1, wherein
the rotation characteristic different from the maximum rotation number is an integration value of the rotation number of each cylinder.

4. The abnormality detection device as in claim 1, further comprising:
an execution condition determining means for determining whether an execution condition for the equalizing means to equalize the maximum rotation numbers is satisfied, wherein
the execution condition determining means determines that the execution condition is satisfied when an operation of the internal combustion engine is an idle operation and also a no-load operation.

5. The abnormality detection device as in claim 1, further comprising:
an execution condition determining means for determining whether an execution condition for the equalizing means to equalize the maximum rotation numbers is satisfied, wherein
when a load is applied to the internal combustion engine, the execution condition determining means determines that the execution condition is satisfied if an operation state of the internal combustion engine is a certain operation state, in which reference injection quantity of the injector can be set in accordance with the load.

6. The abnormality detection device as in claim 5, wherein
the reference injection quantity is the injection quantity that is commanded to the injector based on a predetermined operation state when both of the injector side and the engine side are normal.

7. The abnormality detection device as in claim 5, wherein
the reference injection quantity is an average value of the injection quantities commanded to the injectors of the respective cylinders when the maximum rotation numbers are equalized among the cylinders.
